(19) United States
(12) Patent Application Publication
(10) Pub. No.: US 2007/0254670 A1
(43) Pub. Date: Nov. 1, 2007

(54) System and method for optimizing throughput in a wireless network

(76) Inventors: Dean Kawaguchi, San Jose, CA (US); Vinh-Phuong Tra Le, Fremont, CA (US)

Correspondence Address: FAY KAPLUN & MARCIN, LLP, 15O BROADWAY, SUITE 702, NEW YORK, NY, 10038, US

(21) Appl. No.: 11/415,736

(22) Filed: May 1, 2006

(51) Int. Cl. H04Q 7/20

(52) U.S. Cl. 455/445

(57) ABSTRACT

Described is a system and method for optimizing throughput in a wireless network. The method comprises providing a predetermined wireless bandwidth on a wireless communication channel to a plurality of wireless nodes. A bandwidth used by a selected wireless node is analyzed. When the bandwidth is outside of a predetermined threshold range, a predetermined action is executed to adjust the bandwidth utilized by the selected wireless node.

### FIELD OF INVENTION

The present invention relates generally to measuring and controlling throughput in wireless environments.

### BACKGROUND

In a conventional wireless mesh network, a bandwidth available at each mesh node decreases as a distance from a network management arrangement, e.g., a switch, increases. This may lead to a severe reduction in the bandwidth available at fringe nodes, which are separated from the root node by several intermediate nodes. For example, clients (e.g., mobile units (MUs)) associated with a root node (i.e., mesh node closest to the switch) may have access to the entire bandwidth. Thus, if those clients have a large amount of data to transmit, they may monopolize the entire bandwidth or a significant portion thereof. Any leftover bandwidth may then be utilized by MUs associated with the intermediates nodes. Thus, the MUs associated with the fringe nodes are at a significant disadvantage in the network.

Adding to the problem is that traffic from the MUs associated with the fringe nodes exhibits an increased load relative to similar traffic from MUs associated with the intermediate nodes. Because the traffic from the fringe node must go through several intermediate nodes and the root node before reaching the switch, a data rate at the fringe node is slower, resulting in latency and congestion in the mesh network. Thus, in the conventional mesh network, the MUs associated with the root and intermediate nodes are granted an unfair high priority to the bandwidth in the mesh network.

### SUMMARY OF THE INVENTION

The present invention relates to a system and method for optimizing throughput in a wireless network. The method comprises providing a predetermined wireless bandwidth on a wireless communication channel to a plurality of wireless nodes. A bandwidth used by a selected wireless node is analyzed. When the bandwidth is greater than a predetermined threshold value, a predetermined action is executed to limit the bandwidth utilized by the selected wireless node.

### BRIEF DESCRIPTION OF THE DRAWINGS

FIG. 1 shows an exemplary embodiment of a system for optimizing throughput in a wireless network according to the present invention; and

FIG. 2 shows an exemplary embodiment of a method for optimizing throughput in a wireless network according to the present invention.

### DETAILED DESCRIPTION

The present invention may be further understood with reference to the following description and the appended drawings, wherein like elements are provided with the same reference numerals. The present invention describes a system and method for optimizing throughput in a wireless network. While the exemplary embodiment of the present invention will be described with reference to a wireless mesh network and optimizing bandwidth available at nodes in the mesh, those of skill in the art will understand that the present invention may be utilized in any wireless environment in which distance from a root (e.g., server, mainframe, switch, etc.) has an effect on network conditions, e.g., bandwidth usage, latency, congestion, priority, etc.

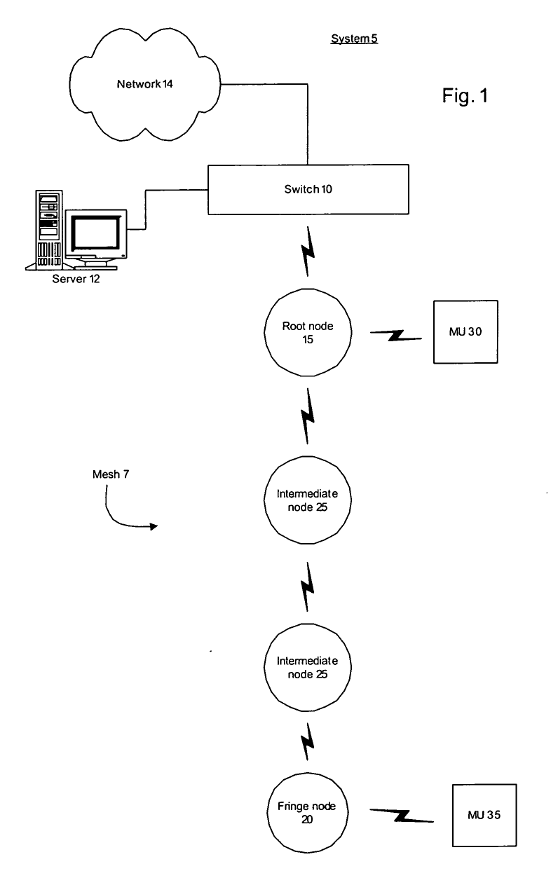

FIG. 1 shows an exemplary embodiment of a system 5 according to the present invention. The system 5 includes a wireless mesh 7 comprising a network management arrangement (e.g., a wireless switch 10) coupled to a plurality of mesh nodes which may referred to as root, intermediate or fringe nodes based on distance from the switch 10. For example, a root node 15 is the mesh node closest to the switch 10, while a fringe node 20 is the mesh node furthest from the switch 10. Intermediate nodes 25 are the at least one mesh node between the root node 15 and the fringe node 20. Those of skill in the art will understand the mesh 7 may include any number of nodes in any configuration, and transmission of wireless signal in the mesh 7 may follow optimizeable transmission paths (e.g., signals travel through a least number of nodes to reach the switch 10).

In the exemplary embodiment, the switch 10 may be deployed in an indoor environment (e.g., a building, warehouse, etc.), while the mesh nodes are deployed in an outdoor environment (e.g., a shipping yard, a parking lot, etc.). The switch 10 may be coupled to a server 12 and a communications network 14 (e.g., a LAN, an intranet, the Internet, etc.). The mesh 7 provides access to the communications network 14 for users of mobile computing units (MUs), e.g., MU 30 and MU 35, in the outdoor environment. Those of skill in the art will understand that the system 5 may be deployed wholly or partially in the outdoor and/or indoor environments.

Wireless communications in the mesh 7 (i.e., between the switch 10 and the root node 15, between the mesh nodes, between the MUs and the mesh nodes) may be executed according to a predetermined wireless communication protocol, e.g., IEEE 802.1x protocol. As understood by those of skill in the art, the 802.1x protocol utilizes a CSMA/CA mechanism to limit congestion on a radio frequency channel utilized for wireless communications. In the exemplary embodiment, wireless communications on the mesh 7 are conducted on a single frequency channel, e.g., 2.4 GHz or 5.1 GHz. Thus, using the CSMA/CA mechanism, a wireless device (e.g., switch 10, mesh node, MUs 30, 35, etc.) waits until the frequency channel is clear before transmitting thereon. For example, the root node 15 may have packets to send upstream (to the switch 10) and downstream (to the intermediate node 25). The root node 15 waits for the frequency channel to be clear (i.e., no transmissions thereon), and then transmits the packets.

In the exemplary embodiment, a predetermined bandwidth/data rate (e.g., approximately 54 mbps) is provided to the root node 15 by the switch 10. Thus, the MUs associated with the root node 15 (e.g., the MU 30) have access to the entire bandwidth (e.g., 54 mbps). However, the bandwidth available at each mesh node decreases as distance from the switch 10 increases. For example, at the intermediate node 25 wirelessly coupled to the root node 15, the available bandwidth may be approximately half the bandwidth available at the root node 15 (e.g., approximately 27 mbps). In the exemplary embodiment, the bandwidth available at each of the mesh nodes may be approximately determined according to the following formula:
BWₙ=BW₀/2ⁿ

where BW is the bandwidth available at node n

n=0 is the root node.

As can be seen from the above formula, the bandwidth available at the fringe node 20 may be severely reduced (i.e., non-linearly) and transmissions to/from the MU 35 may be significantly slower due to the reduced bandwidth, and/or latency and/or congestion at other points in the mesh 7. Additionally, any MU may utilize the entire bandwidth available at the corresponding mesh node, eliminating any bandwidth available to subsequent nodes in the mesh 7. For example, if the MU 30 has a significant amount of data to transfer, the MU 30 may utilize the entire or significant portion of the bandwidth available to the root node 15, substantially reducing or eliminating the bandwidth available to the intermediate nodes 25 and the fringe node 20. The MUs associated with the intermediate nodes 25 and the fringe node 20 (e.g., the MU 35) may be prevented from transmitting on the frequency channel, contributing to latency and congestion in the mesh 7. That is, when the MU 30 is finished transmitting, the remaining MUs may be competing for any remaining bandwidth. Thus, in the conventional system, the MUs associated with the mesh nodes closer to the switch 10 are given an unfair priority to the bandwidth in the mesh 7.

According to the present invention, the switch 10 analyzes a topology of the mesh 7 in an attempt to provide an approximately equal portion of the bandwidth to each mesh node. In another embodiment, the switch 10 allocates the bandwidth based on activity at each mesh node, e.g., increased/high-priority throughput receives increased bandwidth. In the exemplary embodiment, the switch 10 may execute a bandwidth allocation algorithm based on one or more preselected parameters generated based on operation of the mesh 7. For example, the switch 10 may utilize parameters including, but not limited to, a number of nodes in the mesh 7, traffic conditions in the mesh 7 (e.g., at each mesh node), a number of MUs associated with each mesh node, a type of data transmitted by the MUs (voice, data, etc.), etc. to generate a predetermined threshold range (or value) which is indicative of a maximum bandwidth utilizable by a node without inhibiting operation (e.g., reducing available bandwidth) of the remaining nodes.

When the switch 10 determines that a selected mesh node is utilizing a portion of the bandwidth outside of the predetermined threshold range, the switch 10 executes a predetermined action (e.g., throttling) on transmissions from the selected node to provide increased bandwidth to mesh nodes further from the switch 10 than the selected node. For example, if the root node 15 is using a significant portion of the bandwidth and preventing the fringe node 20 from transmitting, the switch 10 may throttle output from the root node 15, reducing bandwidth utilized thereby and making more bandwidth available to the intermediate nodes 25 and the fringe node 20. Those of skill in the art will understand that throttling output of the root node 15 refers to any packets which originate and/or are destined for the root node 15 and/or any MU associated therewith (e.g., the MU 30). Throttling the output may be accomplished in several ways, as will be described below. Additionally, the switch 10 may execute some further predetermined action if the bandwidth utilized by a selected node falls below a minimum value in the threshold range. For example, the switch 10 may indicate that a diagnostic should be run to detect malfunctions in the node.

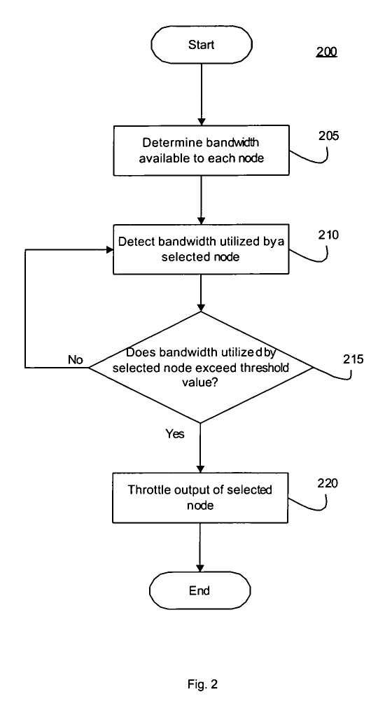

FIG. 2 shows an exemplary embodiment of a method 200 according to the present invention which will be described with reference to the components of the system 5 shown in FIG. 1. In step 205, the switch 10 estimates a portion of bandwidth available to each node in the mesh 7. In the exemplary embodiment, the bandwidth available to each node is substantially equal, and may be determined as follows:
BWₙ=BW₀/n

Where BW is the bandwidth available at node n

n=0 is the root node.

In the mesh 7 shown in FIG. 1, the bandwidth available at each node would be approximately 54 mbps divided by a total number of nodes in the mesh 7 (or a total number of nodes stemming from each root node, for meshes with multiple root nodes coupled to the switch 10). When the bandwidth available to each node is determined, it may be stored as a predetermined threshold value.

The bandwidth available to each node may alternatively or additionally take into account one or more of the parameters reflecting operation of the mesh 7. For example, the switch 10 may take into account a total number of nodes in the mesh 7, traffic conditions in the mesh 7 and/or at each node, a number of MUs associated with each node, a type of data transmitted by the MUs (voice, data, etc.) associated with each node, etc.

In step 210, the switch 10 detects the bandwidth utilized by a selected node in the mesh 7. For example, the switch 10 may initially begin at the root node 15 and detect the bandwidth utilized thereby, followed by each node within the mesh 7. Those of skill in the art will understand that the bandwidth utilized by, for example, the root node 15, may be calculated based on amount/type of output of the MU 30 and other MUs associated with the root node 15. For example, if the MU 30 is transmitting voice data, it may utilize more bandwidth than an MU transmitting web page requests, emails, etc.

In step 215, the switch 10 determines whether the bandwidth utilized by the selected node is greater than the predetermined threshold value. As noted above, the threshold value may be the total bandwidth available divided by the number of nodes in the mesh 7, generated based on or more of the preselected parameters. In the exemplary embodiment, the switch 10 compares the bandwidth utilized to the threshold value to determine whether the selected node is usurping bandwidth allocated to other mesh nodes. In other embodiments, the threshold value may be embodied in a predefined range, i.e., the threshold value plus or minus a preselected amount of bandwidth, or a time over which bandwidth exceeding the threshold value is utilized. In this embodiment, the switch 10 may not respond to subtle variations in the bandwidth utilized which may correspond to the root node 15 supporting association of another MU, or a spike in the bandwidth utilized.

When the bandwidth utilized by the selected node (e.g., the root node 15) is greater than the threshold value, the switch 10 executes a predetermined action to throttle the output of the root node 15. The action may include, but is not limited to, dropping packets received from the root node 15, introducing a delay into communications with the root node 15, etc. For example, the switch 10 may drop one or more packets received from the root node 15 so that the MUs which transmitted the packets (e.g., the MU 30) do not receive acknowledgments from the switch 10. According to the wireless protocol, the MU 30 will not transmit another packet until it receives the acknowledgement from the switch 10. Thus, the MUs must re-contend for the frequency channel and retransmit the packets. The number of packets dropped may be determined based on an amount of throttling of the root node 15. In the exemplary embodiment, the number of packets dropped by the switch 10 is based on a reduction of the bandwidth utilized by the root node 15 to the bandwidth determined in step 205.

In another exemplary embodiment, the switch 10 introduces a delay into communications with the root node 15 by, for example, delaying the acknowledgment of packets transmitted by MUs associated with the root node 15. The MU 30 may transmit a first packet to the root node 15 which relays the first packet to the switch 10. Under the wireless protocol, the MU 30 will not transmit a second packet until an acknowledgement is received from the switch 10. According to the present invention, the switch 10 may delay transmitting the acknowledgment to the MU 30 for a predetermined time period. During the time period, the MU 30 is not utilizing and/or contending for the frequency channel, leaving it clear for transmissions from the intermediate nodes 25, the fringe node 20 and/or any MUs associated therewith. The predetermined time period may be generated based, for example, the bandwidth utilized by the root node 15.

The present invention gives the fringe nodes in the mesh network a fair chance to utilize the bandwidth provided thereto. That is, the unfair priority granted to nodes closer to the switch may be eliminated or substantially reduced by throttling the output thereof.

The present invention has been described with reference to an exemplary embodiment. One skilled in the art would understand that the present invention may also be successfully implemented, for example, in alternative embodiments. Accordingly, various modifications and changes may be made to the embodiments without departing from the broadest spirit and scope of the present invention as set forth in the claims that follow. The specification and drawings are accordingly to be regarded in an illustrative rather than restrictive sense.

What is claimed is:

1. An arrangement, comprising:
a communications arrangement providing a predetermined wireless bandwidth on a wireless communication channel to a plurality of wireless nodes; and
a processor analyzing a bandwidth used by a selected wireless node,
wherein, when the bandwidth is outside of a predetermined threshold range, the processor executes a predetermined action to adjust the bandwidth utilized by the selected wireless node.

2. The arrangement according to claim 1, wherein the arrangement is one of a switch, a router, a hub and an access point.

3. The arrangement according to claim 1, wherein the processor generates the predetermined threshold range as a function of at least one of (i) the predetermined wireless bandwidth, (ii) a number of the plurality of wireless nodes, (iii) data traffic on the wireless communication channel, (iv) a number of wireless computing units associated with each of the wireless nodes and (v) a communication type of each of the wireless computing units.

4. The arrangement according to claim 3, wherein the communication type is one of voice, data, video and emergency.

5. The arrangement according to claim 3, wherein the predetermined threshold range is one of (i) an amount of bandwidth, (ii) a range of bandwidth and (iii) a time period for which the bandwidth utilized by the selected node may be outside of the predetermined threshold range, wherein at the expiration of the time period, the processor executes the predetermined action.

6. The arrangement according to claim 1, wherein the predetermined action is at least one of (i) throttling transmissions from the selected node, (ii) delaying acknowledgements of transmissions from the selected node and (iii) dropping packets transmitted from the selected node.

7. The arrangement according to claim 1, wherein the wireless nodes are one of access points and access ports.

8. The arrangement according to claim 3, wherein each of the wireless computing units includes at least one of an image-based scanner, a laser-based scanner, an RFID reader, an RFID tag, a cell phone, a tablet, a PDA and a network interface card.

9. A method, comprising:
providing a predetermined wireless bandwidth on a wireless communication channel to a plurality of wireless nodes;
analyzing a bandwidth used by a selected wireless node; and
when the bandwidth is outside of a predetermined threshold range, executing a predetermined action to adjust the bandwidth utilized by the selected wireless node.

10. The method according to claim 9, further comprising:
generating the predetermined threshold range as a function of at least one of (i) the predetermined wireless bandwidth, (ii) a number of the plurality of wireless nodes, (iii) data traffic on the wireless communication channel, (iv) a number of wireless computing units associated with each of the wireless nodes and (v) a communication type of each of the wireless computing units.

11. The method according to claim 10, wherein the communication type is one of voice, data, video and emergency.

12. The method according to claim 10, wherein the predetermined threshold range is one of (i) an amount of bandwidth, (ii) a range of bandwidth and (iii) a time period for which the bandwidth utilized by the selected node may be outside of the predetermined threshold range.

13. The method according to claim 9, wherein the executing step includes at least one of the following substeps:
(i) throttling transmissions from the selected node;
(ii) delaying acknowledgements of transmissions from the selected node; and
(iii) dropping packets transmitted from the selected node.

14. The method according to claim 10, wherein the wireless computing unit includes at least one of an image-based scanner, a laser-based scanner, an RFID reader, an RFID tag, a cell phone, a tablet, a PDA and a network interface card.

15. A system, comprising:
a plurality of wireless nodes; and
a network management arrangement (NMA) providing a predetermined wireless bandwidth on a wireless communication channel to the plurality of wireless nodes, the NMA analyzing a bandwidth used by a selected wireless node,
wherein, when the bandwidth is outside of a predetermined threshold range, the NMA executes a predetermined action to adjust the bandwidth utilized by the selected wireless node.

16. The system according to claim 15, wherein the NMA includes at least one of a switch, a router, a hub and an access point.

17. The system according to claim 15, wherein the NMA generates the predetermined threshold range as a function of at least one of (i) the predetermined wireless bandwidth, (ii) a number of the plurality of wireless nodes, (iii) data traffic on the wireless communication channel, (iv) a number of wireless computing units associated with each of the wireless nodes and (v) a communication type of each of the wireless computing units.

18. The system according to claim 17, wherein the communication type is one of voice, data, video and emergency.

19. The system according to claim 17, wherein the predetermined threshold range is one of (i) an amount of bandwidth, (ii) a range of bandwidth and (iii) a time period for which the bandwidth utilized by the selected node may be outside of the predetermined threshold range, wherein at the expiration of the time period, the processor executes the predetermined action.

20. The system according to claim 15, wherein the predetermined action is at least one of (i) throttling transmissions from the selected node, (ii) delaying acknowledgements of transmissions from the selected node and (iii) dropping packets transmitted from the selected node.

21. The system according to claim 15, wherein the wireless nodes are one of access points and access ports.

22. The system according to claim 17, wherein each of the wireless computing units includes at least one of an image-based scanner, a laser-based scanner, an RFID reader, an RFID tag, a cell phone, a tablet, a PDA and a network interface card.

23. An arrangement, comprising:
a communications means for providing a predetermined wireless bandwidth on a wireless communication channel to a plurality of wireless nodes; and
a processing means for analyzing a bandwidth used by a selected wireless node,
wherein, when the bandwidth is outside of a predetermined threshold range, the processing means executes a predetermined action to adjust the bandwidth utilized by the selected wireless node.
